(19) United States
(12) Patent Application Publication
(10) Pub. No.: US 2016/0008925 A1
(43) Pub. Date: Jan. 14, 2016

(54) DECORATIVE ARTICLE AND METHOD FOR MAKING DECORATIVE ARTICLE

(71) Applicant: Frank Malvasio, Tamarac, FL (US)

(72) Inventor: Frank Malvasio, Tamarac, FL (US)

(21) Appl. No.: 14/329,513

(22) Filed: Jul. 11, 2014

(51) Int. Cl. B23K 26/36

(52) U.S. Cl. CPC B23K 26/365

(57) ABSTRACT

A process for making a decorative article of manufacture comprising entering a pattern in a laser engraver; placing an article having a top surface to be engraved in the laser engraver; laser engraving the top surface of the article to form a relief in the top surface; applying a UV curable resin into the laser engraved areas; exposing the UV curable resin or bond to a UV light; applying liquid ceramic composite material upon the UV curable resin within the laser engraved areas; placing the article in a pressure polymerization oven at approximately 4 bar; treating the article in the oven for approximately 90 minutes at 95 degrees C.; and removing excess ceramic composite material from the article.

### CROSS-REFERENCE TO RELATED APPLICATION

This application relates to the same subject matter as co-pending provisional patent application Ser. No. 61/845,114, filed by the same applicant on Jul. 11, 2013. This application claims the Jul. 11, 2013 filing date as to the common subject matter.

### BACKGROUND OF THE INVENTION

1. Field of Invention

The present invention relates to a decorative article and method for making a decorative article. It applies particularly to the use of a curable resin and ceramic placed in a relief of an article, and will be described with particular reference thereto.

2. Background of Invention

Many ornaments and other articles are decorated with contrasting decorative inlays, veneers or inserts. These inserts allow for attractive designs on the articles, such as flatware. The process of the present invention allows for the use of a ceramic inlay which allows the inlay to stand out clearly against the article itself. Thus the new process allows a design such as a logo to stand out prominently, thereby making it an effective marketing item as well as a decorated article.

### SUMMARY OF THE INVENTION

In accordance with the invention, a decorated article and a method for decorating an article are provided.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a flow chart for the method of the invention.

FIG. 2 is an illustration of the article in a laser engraver.

FIG. 3 is a detail illustration of an engraved article.

FIG. 4 is an illustration of UV exposure upon the resin in a relief on an article.

FIG. 5 is an illustration of ceramic being placed in a relief on an article.

FIG. 6 is an illustration of a decorative article being removed from a pressure polymerization oven.

FIG. 7 is an illustration of a decorative article.

FIG. 8 is an illustration of a decorated article that has further been metal plated.

### DETAILED DESCRIPTION OF THE INVENTION

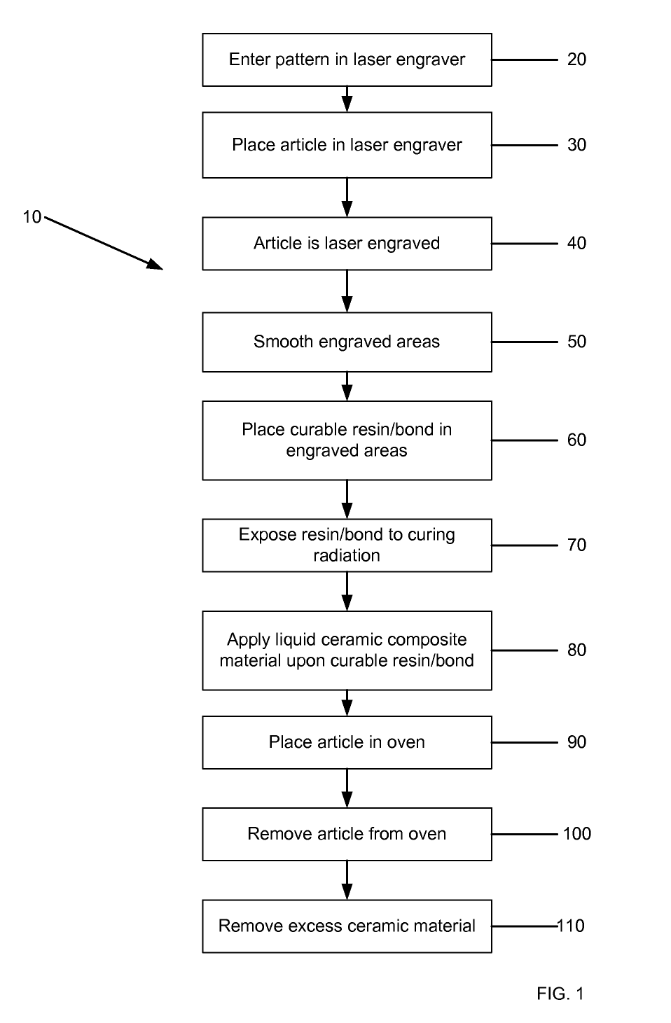

With reference to FIGS. 1-8, a decorative article and a method of decorating an article is provided.

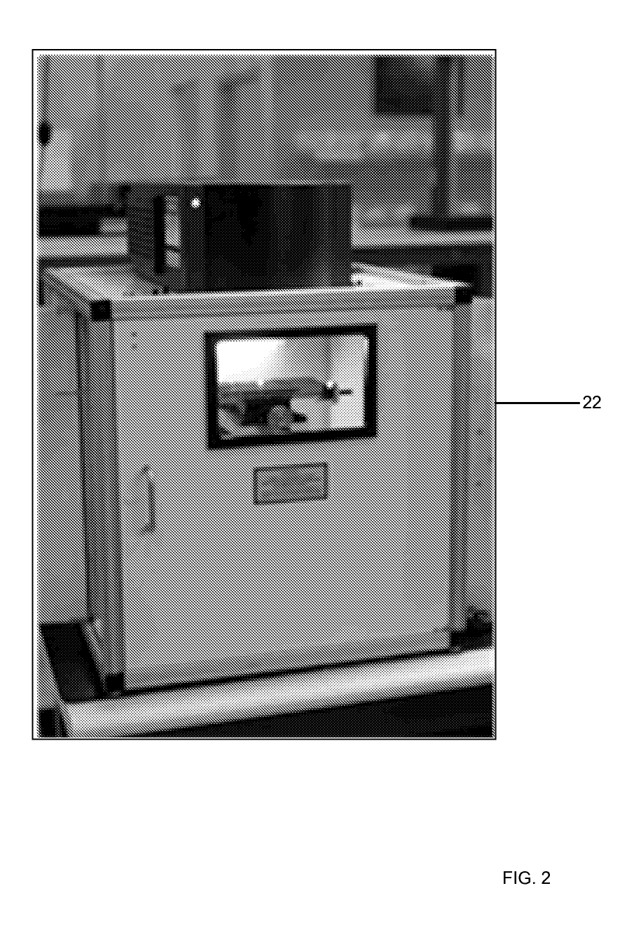

The steps for the method are described in the flow chart 10 of FIG. 1. The process for making a decorative article of manufacture includes the step of entering a pattern in a laser engraver 20. A typical laser engraver 22 is shown in FIG. 2.

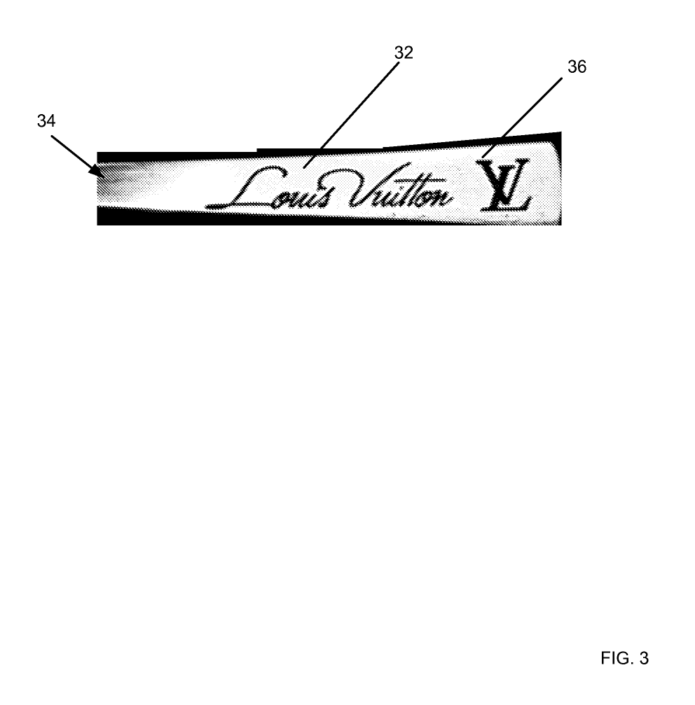

Next, an article such as a utensil or tool to be decorated is placed in the laser engraver 30. As shown in FIG. 3, the laser engraving is to be performed on a top surface 32 of the article 34. The article 34 is then laser engraved to form a relief 36 in the top surface 34. The depth of the relief 36 is to be made to approximately 0.5 mm in depth. The article is then laser engraved 40.

After laser engraving, the engraved areas may be smoothed 50. One process for smoothing is sandblasting. However, other equivalent processes are known in the art. After smoothing, the article may then be cleaned and/or rinsed before the next step in the process.

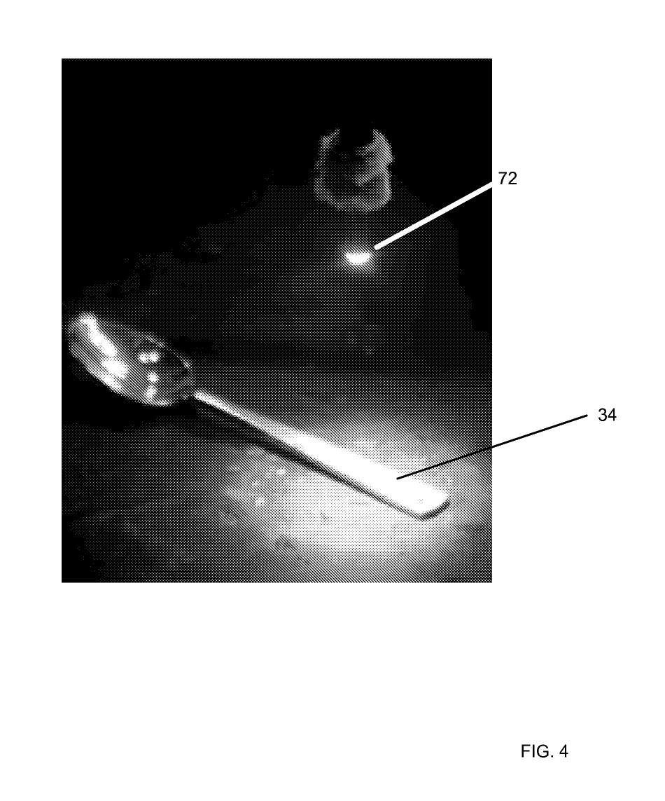

Next a curable resin or bond such as an ultraviolet light curable resin or bond is placed in the laser engraved relief 60. The curable resin may be clear so as not to interfere with the color of the liquid ceramic material to be included at a later step. The UV curable resin is inserted in the relief. As shown in FIG. 4, the UV curable resin in the relief 36 is then exposed to curing radiation 70 such as UV light 72. The UV light exposure may be performed by placing the article 34 under a 340 nanometer UV bulb placed approximately 6 inches from the article 34 for approximately 30 seconds. This exposure helps make the resin or bond more receptive to the application of the liquid ceramic material.

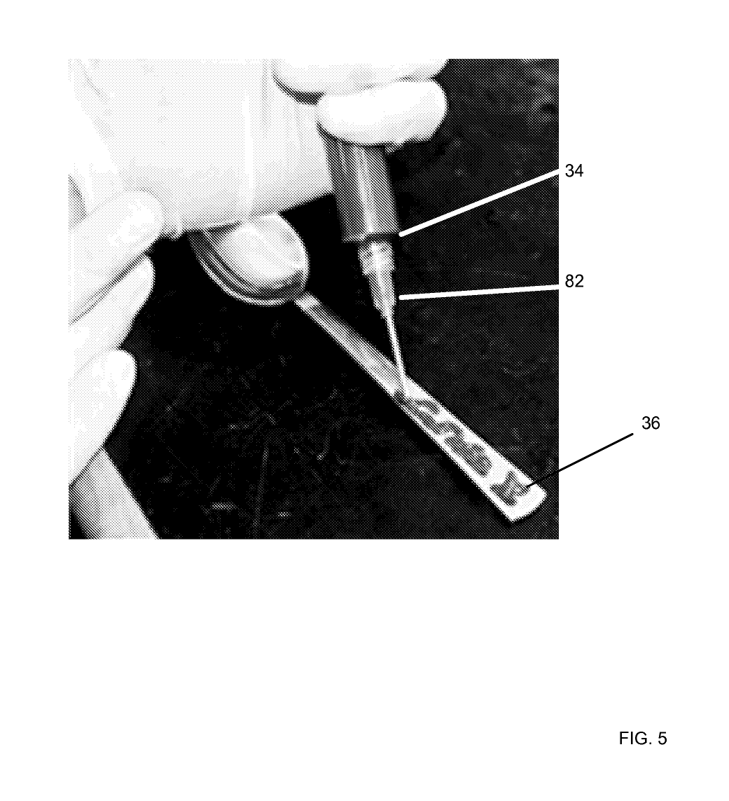

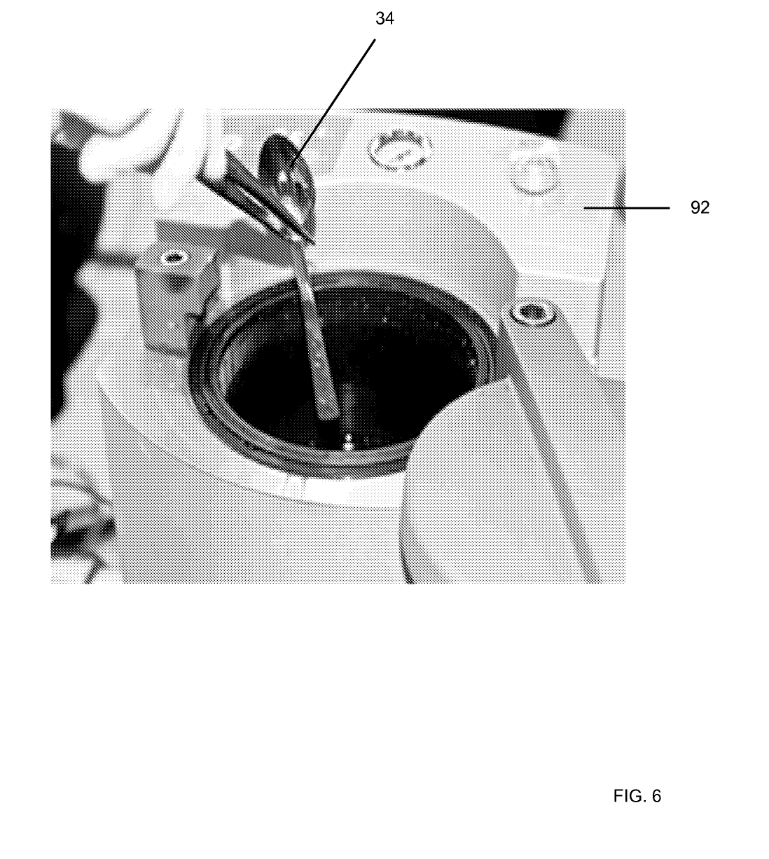

Next, a liquid ceramic composite material is applied upon the UV curable resin located within the laser engraved areas 80. As shown in FIG. 5, the liquid ceramic composite material 82 is applied upon the UV curable resin located within the laser engraved relief 36. The article 34 is then placed in a pressure polymerization oven 90. One oven for use is illustrated at 92 in FIG. 6. The oven may be pressurized to approximately 4 bar. The article 34 is then treated in the oven for approximately 90 minutes at 95 degrees C., in an approximately 99% glycerin solution. The article 34 is immersed in the solution for the treatment.

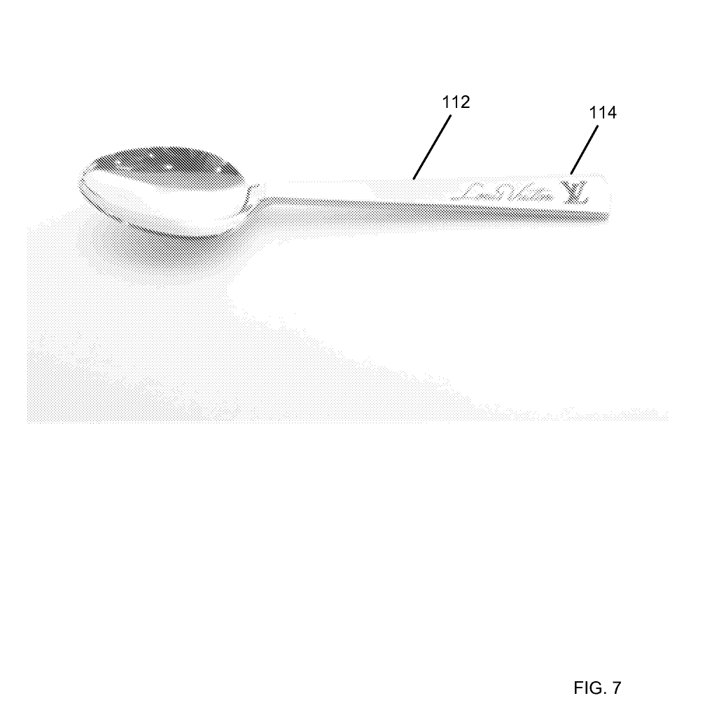

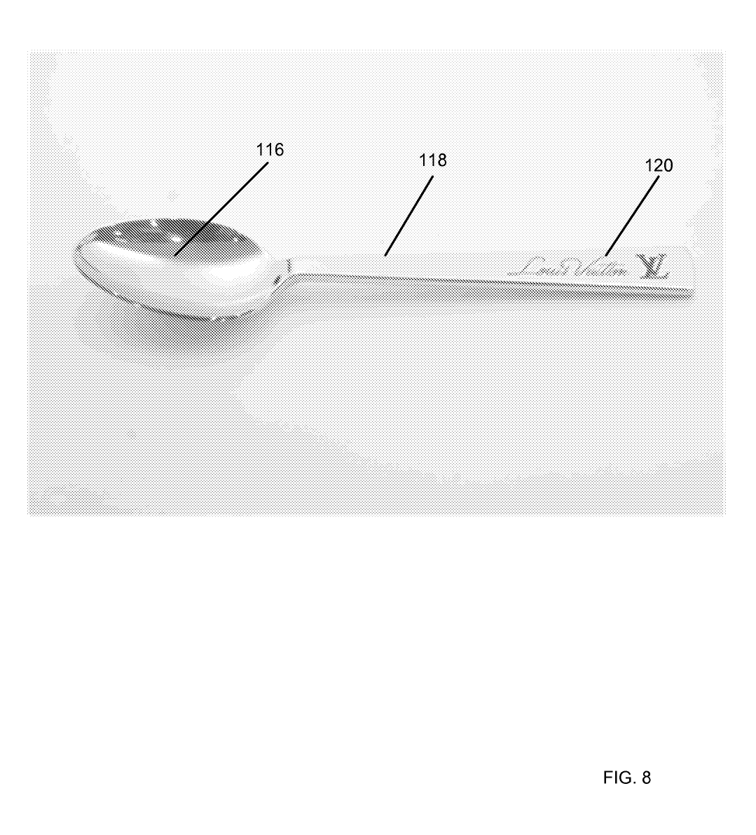

After treatment in the oven 92, the article 34 is then removed 100 from the oven 92 with decorative material made from the resin and the ceramic composite material located in the relief. Excess ceramic composite material may then be removed 110 from the article 34. The removal of excess ceramic composite material may be accomplished by grinding and polishing or other equivalent methods known in the art. Examples of finished articles are shown in FIGS. 7 and 8. In FIG. 7, a decorated article 112 with the design 114 is finished after grinding and polishing. In FIG. 8, an alternative embodiment is shown in which a decorated plated article 116 is shown with plating 118 on the article around the design 120. Metal plating may be made of gold, silver, alloys, or other metals known in the art. The plating method may also be performed by methods known in the art, such as electroplating, hand-laying, or other known methods.

The article created by the method taught is highly decorative and allows the use of new materials to provide for a design or logo on the article that is attractive and easy to notice.

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

The inventors claim the method, system and apparatus described herein:

1. A process for making a decorative article of manufacture comprising the steps of:
(a) entering a pattern in a laser engraver;
(b) placing an article having a top surface to be engraved in the laser engraver;
(c) laser engraving the top surface of the article to form a relief in the top surface;
(d) applying a curable resin into the relief;
(e) exposing the curable resin to a curing radiation;
(f) applying liquid ceramic composite material upon the curable resin within the relief;
(g) placing the article in a pressure polymerization oven;
(h) treating the article in the oven at approximately 4 bar for approximately 90 minutes at 95 degrees C.; and
(i) removing excess ceramic composite material from the article.

2. The process of claim 1, wherein the curing radiation is UV light.

2. The process of claim 1, further including the step of smoothing the laser engraved areas of the article after the step of laser engraving the article.

3. The process of claim 2, further including the step of cleaning and rinsing the article after the step of smoothing the laser engraved areas of the article.

4. The process of claim 1, wherein the curable resin is clear.

5. The process of claim 1, wherein the relief has a depth of approximately 0.5 mm.

6. The process of claim 1, wherein the step of removing excess ceramic composite material comprises grinding and polishing.

7. The process of claim 1, further comprising the step of plating the article with a metal after the step of removing excess ceramic composite material from the article.

8. The process of claim 1, wherein the polymerization oven contains an approximately 99% glycerin solution.

9. The process of claim 1, wherein the step of removing excess ceramic composite material from the article material comprises grinding and polishing the top surface of the article.

10. A decorative article of manufacture, comprising:
an article, comprising,
a top surface having a relief containing a decorative material, wherein the decorative material is created by:
creating a relief by laser engraving;
applying a curable resin into the relief;
exposing the curable resin to a curing radiation;
applying liquid ceramic composite material upon the curable resin within the relief;
inserting the article into a pressure polymerization oven; and
curing the article in the pressure polymerization oven at 4 bar for approximately 90 minutes at 95 degrees C.

11. The article of manufacture of claim 10, wherein the curing radiation is UV light.

12. The article of manufacture of claim 10, further comprising the step of plating the article with a metal after the step of removing excess ceramic composite material from the article so that the metal is located around the design.

13. The article of manufacture of claim 10, wherein the polymerization oven contains an approximately 99% glycerin solution.

14. The article of manufacture of claim 10, wherein the step of removing excess ceramic composite material from the article material comprises grinding and polishing the top surface of the article.
